(19) United States
(12) Patent Application Publication
(10) Pub. No.: US 2022/0042663 A1
(43) Pub. Date: Feb. 10, 2022

(54) RETROFIT LIGHT MOUNT

(71) Applicant: LONGHORN INTELLIGENT TECH CO., LTD., Shenzhen (CN)

(72) Inventors: Haitao YANG, Shenzhen (CN); Min Liu, Shenzhen (CN); Xingwei Huang, Shenzhen (CN); Lei Li, Shenzhen (CN); Lin Yang, Shenzhen (CN)

(21) Appl. No.: 16/986,625

(22) Filed: Aug. 6, 2020

(51) Int. Cl. F21S 8/02; F21K 9/233; F21S 4/20; F21V 15/01; F21V 7/00; F21V 23/00

(52) U.S. Cl. CPC F21S 8/026; F21K 9/233; F21S 4/20; F21Y 2115/10; F21V 7/005; F21V 23/008; F21V 15/01

(57) ABSTRACT

A retrofit light mount has a pivot rack configured to install to a T-bar frame. The pivot rack is elongated and has a U shape when viewed from above. A lamp has an LED box and a reflector. The lamp has a pivot end and a distal end. A pair of spade hooks are formed on the pivot end, including a first spade hook and a second spade hook. An inside rack vertical portion is formed on the pivot rack. The inside rack vertical portion is a vertically oriented panel. A first notch and a second notch are formed on the inside rack vertical portion. The first notch is configured to receive the first spade hook, and the second notch is configured to receive the second spade hook.

### FIELD OF THE INVENTION

The present invention is in the field of retrofit light mounting.

### DISCUSSION OF RELATED ART

When installing ceiling lamps to a drop ceiling T track frame there is a high risk and installer dropping the lamp. The difficulty in preparing a reliable and safe suspension makes the installation process prone to accidents during the installation. During the installation process, professional tools are often needed to complete the installation. Accidents can happen when a user drops the lamp frame from close to the ceiling. A variety of different connection mechanisms have been made for improving the structural stability and safety of lamp installations and lamp retrofits.

For example, in U.S. Pat. No. 10,274,171 Adjustable LED Light Fixture For Use In A Troffer by inventor Dave Goelz et al. published on Apr. 30, 2019, the abstract discloses, “The light fixture is configured to be mounted in a troffer. The light fixture includes a light emitting assembly including at least one LED and a reflector assembly. A mechanical attachment mechanism is configured to be connected directly between the light fixture and a troffer. The mechanical attachment mechanism is adjustable such that a distance between the light fixture and the troffer may vary. The mechanical attachment mechanism may comprise at least one bracket pivotably connected to the light fixture, a cable having an attachment structure wherein the effective length of the cable is adjustable, a telescoping bracket having an attachment structure wherein the effective length of the telescoping bracket is adjustable, a threaded member having an attachment structure wherein the effective length of the threaded member is adjustable by a threaded nut that engages the threaded member. The mechanical attachment mechanism positively secures the light fixture to the troffer without gaps to create an electrical enclose that prevents risk of fire or shock.”

Also for example, U.S. Pat. No. 10,174,915 entitled Troffer Light Fixture Retrofit Systems And Methods by inventor John Scribante et al. published Jan. 8, 2019 the abstract discloses, “A retrofitting kit for retrofitting an existing troffer light fixture having a troffer housing includes a door assembly and a retainer including a flange. The flange is deformable between a first position and a second position. The light source is within the housing. The retainer includes the flange coupled to the housing of the door assembly. The retainer is configured to engage at least one of the troffer housing and a T-bar of a ceiling system to thereby selectively secure the door assembly within the ceiling system when the flange is in the first position. The retainer is further configured to facilitate at least one of installation and removal of the door assembly when the flange is in the second position.”

For example, in U.S. Pat. No. 10,012,352 Troffer Light Fixture Retrofit Systems And Methods by inventor John Scribante et al. published Jul. 3, 2018 the abstract discloses, “A retrofitting kit for retrofitting an existing troffer light fixture having a troffer housing includes an adaptor bracket and a door assembly. The adaptor bracket includes a channel configured to rest on a T-bar of a ceiling system, and further configured to be located between the T-bar and the troffer housing. The channel defines an aperture configured to accept either a hinge or a latch of the door assembly, and the channel defines a latch surface. The door assembly includes a hinge configured to interface with the adaptor bracket, a latch configured to engage the latch surface of the adaptor bracket to hold the door assembly in a closed position, a housing including the latch and the hinge, and a light source coupled to the housing.”

For example, in United States patent entitled Retrofit Kit For Drop Ceiling Lighting Fixtures by inventor Russell A. Price published Jan. 23, 2018 the abstract discloses, “A retrofit kit for drop ceiling lighting fixtures and a method of retrofitting drop ceiling lighting fixtures are provided. The retrofit kit includes a pair of adapter brackets configured to be mounted to opposing sides of a drop ceiling fixture, and a door-light assembly configured to be pivotally coupled to one adapter bracket, and to be latched to the other adapter bracket.”

For example, in U.S. Pat. No. 9,182,091 LED Panel Light Fixture by inventor David Gershaw published Nov. 10, 2015 the abstract discloses, “Devices, systems, and methods are provided for both retrofitting existing lighting fixtures with LED panels and for installing ceiling tiles having LED modules incorporated therewith. In one exemplary embodiment, a thin panel includes an LED module integrated therewith and the panel is disposed over an opening in a troffer to provide light from the panel-module combination. In another exemplary embodiment, a ceiling tile includes an LED module integrated therewith and the tile is placed in a ceiling grid so light can be provided from that tile. Exemplary configurations of the systems, devices, and kits, as well as methods for installing the same, are also provided.”

Also for example, in U.S. Pat. No. 8,523,383 entitled Retrofitting Recessed Lighting Fixtures by inventor Valerica Grigore et al., published Sep. 3, 2013 the abstract discloses, “A retrofit kit assembly for a recessed lighting fixture and methods for manufacturing and installing the same are described herein. The retrofit kit includes at least two mounting brackets, which can each include at least one lamp socket. The kit also includes at least one ballast, which may be pre-wired to the sockets. Each ballast may include a temporary adhesive on a mounting side thereof, for use during the installation process. For example, the installer may provisionally mount the ballast to an interior surface of an existing housing of the fixture and then permanently mount the ballast using one or more fasteners. The mounting brackets and ballast of the kit may include captive hardware which is held in place in the aperture for the fastener prior to fastening the particular object to the recessed housing, which reduces risk of dropping or losing fasteners during installation.”

### SUMMARY OF THE INVENTION

The present invention is a system and method for retrofitting an existing recessed light fixture. An object of the present invention is to improve the retrofit connection for ease of installation replacement with a more efficient light source, replacement of a damaged recessed light fixture. The recessed light fixture is generally installed on the ceiling. The system contains a square or rectangular disc-shaped housing and a light source. The ceiling system is a suspended ceiling system, a ceiling grille system or a ceramic tile system, or other engineered ceiling systems. The groove lamp includes a disc-shaped housing, and the housing includes a top wall and four side walls. The light source, lamp holder, lighting ballast, wiring device and/or other components that accept mains input are usually installed in the troffer housing. The recessed light fixture also includes a frame attached to the recessed housing. The frame may be a facia or a component including a facia or lens.

The present invention works with the three main types of ceiling track lamps. The present invention can use two vertical U or Z shaped brackets. When implementing brackets, the brackets are installed on the front and back sides of the lamp. Also, securement means may include U or Z-shaped grooves with two or more horizontal planes and two or more vertical planes and other special-shaped brackets. The brackets are installed at both ends of the lamps against the grooves and T-shaped frameworks. The bracket installation needs to be secured on the groove. After installation, there will be grooves on both sides of the lamp.

Additionally, a horizontal plane and a vertical plane L-shaped bracket can be formed on both sides and both ends of the lamp or light source. The bracket has a mounting hole or slot and a fixing hole or slot. The brackets at both ends are installed in the groove. Between the T-frames, the brackets on both sides are installed between the brackets on both ends and the groove T-frames. The two ends of the lamp or light source have rotating shafts or hinges and rotating buckles or slide buckles. Optionally, the hinge can be suspended on the brackets at both ends. After connecting and installing the internal parts or accessories, the installer rotates the lamp from a vertical position to a horizontal position. The user then engages the slide lock or the pivot lock.

A pivot rack is formed as a U-shaped bracket with a groove and a hook on the lamp can engage a connector. During installation, the U-shaped bracket plays a role of connecting and fixing with the lamp panel by wrapping the disc-shaped shell, instead of fixing the bracket with the locking screw. Afterwards, using two hooks on one end of the lamp, the user hooks the two hooks onto the pivot rack. The third step is rotating the slide lock or the pivot lock. Because the length and width of the lamp are designed to be greater than the length and width of the T-bar ceiling track frame, the lamp fills the gap between the lamp and the T-bar frame to provide a clean installation look and continuous support.

A retrofit light mount has a pivot rack configured to install to a T-bar frame. The pivot rack is elongated and has a U shape when viewed from above. A lamp has an LED box and a reflector. The lamp has a pivot end and a distal end. A pair of spade hooks are formed on the pivot end, including a first spade hook and a second spade hook. An inside rack vertical portion is formed on the pivot rack. The inside rack vertical portion is a vertically oriented panel. A first notch and a second notch are formed on the inside rack vertical portion. The first notch is configured to receive the first spade hook, and the second notch is configured to receive the second spade hook.

The first notch and the second notch have shoulder that slope toward them to provide a funnel for ease of installation. A first notch right shoulder is preferably formed to the right of the first notch and a first notch left shoulder is formed to the left of the first notch. Similarly, a second notch right shoulder and a second notch left shoulder slope toward the second notch. The second notch right shoulder is formed to the right of the second notch, and the second notch left shoulder is formed to the left of the second notch. The pivot rack has a U shape when viewed from above.

The spade hook has a spade hook base, wherein a spade hook post extends upwardly from the spade hook base. The spade hook top panel extends forwardly from the spade hook post, wherein the spade hook tip panel extends downwardly from the spade hook top panel. The lamp further includes an edge retainer mounted at a distal end. The edge retainer has an edge retainer base connected to the lamp. An edge retainer protruding portion extends upwardly from the edge retainer base. An edge retainer extension tab extends laterally from the edge retainer protruding portion. The pivot rack further includes a second vertical edge panel forward of the inside rack vertical portion. The second vertical edge panel is parallel to the inside rack vertical portion.

The pivot rack further includes a first vertical edge panel and a third vertical edge panel. The first vertical edge panel is parallel to the third vertical edge panel. The first vertical edge panel is perpendicular to the inside rack vertical portion. The third vertical edge panel is perpendicular to the inside rack vertical portion. The third vertical edge panel is spaced apart from the inside rack vertical portion at a first inside opening. The first vertical edge panel is spaced apart from the inside rack vertical portion at a second inside opening.

### BRIEF DESCRIPTION OF THE DRAWINGS

FIG. 1 is an exploded view of the present invention.

FIG. 2 is a schematic diagram of the parts of the panel light.

FIG. 3 is a diagram showing detail of the pivot rack.

FIG. 4 is an exploded assembly view showing lamp placement within the troffer.

FIG. 5 is a cross section view showing pivot rack connection to the T-bar.

FIG. 6 is a cross section view showing pivot rack connection to the T-bar.

FIG. 7 is an installation view showing the view from a user installing the device.

FIG. 8 is an installed view showing the device after installation.

FIG. 9 is a plan view of the retrofit lamp with slide latch.

The following call out list of elements can be a useful guide in referencing the element numbers of the drawings.
21 Pivot Rack
22 First Notch
23 Rack Upper Edge
24 First Notch Right Shoulder
25 Left Notch Left Shoulder
26 Second Notch
27 Second Notch Right Shoulder
28 Second Notch Left Shoulder
29 Inside Rack Vertical Portion
30 Lamp
31 Ballast Or Driver
32 Led Box
33 Spade Hook
34 Reflector
35 Left Side
36 Right Side
37 Rear Side
38 Front Side
39 Edge Retainer Mount Areas
40 Rack Vertical Portion
41 Spade Hook Tip Panel
42 Spade Hook Post
43 Spade Hook Base
44 Spade Hook Tip Panel
45 First Tip End
46 Second Tip End
50 Edge Retainer
51 Edge Retainer Base
52 Edge Retainer Extension Tab
53 Edge Retainer Protruding Portion
54 Edge Retainer Extension Handle
55 Edge Retainer Hole
61 First Vertical Edge Panel
62 Second Vertical Edge Panel
63 Third Vertical Eedge Panel
64 Horizontal Portion
65 Web Section
66 First Corner Opening
67 Second Corner Opening
68 First Inside Opening
69 Second Inside Opening
70 Troffer Housing
71 T-Bar Frame
72 Pivot End
73 Distal End
74 Pivot Latch
75 Slide Latch
76 Slide Latch Bar
77 Slide Latch Mount

### DETAILED DESCRIPTION OF THE PREFERRED EMBODIMENT

The present invention is a system and method for retrofitting an existing drop ceiling light fixture. An existing light fixture can be replaced with a more efficient lamp due to damage or just for upgrading. Recessed lights are typically mounted on the ceiling on an existing T-bar frame suspended from the ceiling as a drop ceiling. The recessed light fixture is generally installed on the drop ceiling on the T-bar frame. The installer can remove the legacy electronic components including the ballast, driver or other devices by removing the lens of the existing lamp. The installer then disconnects the power supply. The installer then installs the pivot rack which acts as an adapter bracket that engages the T-bar frame. The lamp is then hung on the pivot rack. The lamp can then be swung from the open position to the closed position. After swinging to the closed position, the lamp is locked to the T-bar frame. After locking the lamp to the T-bar frame, the installer can reconnect the power supply. Preferably, the recessed portion of the lamp is larger than the T-bar frame so that the recessed portion of the lamp rests on the T-bar frame. A bracket, swivel latch, slide latch or other connection means can lock the lamp to the T-bar frame. The lamp optionally has hooks on the pivot end and latches on the outside end so that the workers on ladders can install the retrofit lamp without tools.

The system has a square or rectangular disc-shaped housing and a light source. The ceiling system is a suspended ceiling system, a ceiling grille system or a tile system, or other engineered ceiling systems. The groove lamp could include a disc-shaped housing, and the housing could include a top wall and four side walls. The light source, lamp holder, lighting ballast, wiring device and/or other components that accept mains power input are usually installed in the troffer. The light fixture also includes a frame attached to the troffer.

The present invention has a key feature which is the recessed U-shaped bracket to be installed in cooperation with the hook on the lamp or the light source at a near end and locked with a latch at a far end. The U-shaped bracket has a U-shaped when viewed from above. The front side 38 has a pivot end, and the rear side 37 has a distal end.

The method of installation has a few steps. The first step is to affix the pivot rack 21 to the lamp panel. The pivot rack 21 is shaped as a U-shaped bracket. The pivot rack 21 is formed as a bracket that can have a locking latch with a locking handle. The second step is to hook the lamp 30 on to the pivot rack 21 using the two hooks mounted to the lamp. The groove of the U-shaped bracket receives the hooks. The user then connects the input wire of the lamp and installs the safety rope of the lamp. In the third step, the lamp is turned up to be parallel to the T-shaped keel through the hook as a rotating shaft, and two rotating iron pieces (or bolts like bolts) are installed on the other end of the lamp, and then the rotating iron piece is rotated by the handle (or pushed by the handle) Latch), lean on the middle of the T-frame to complete the installation. Because the length and width of the lamp are designed to be ≥the length and width of the T-shaped skeleton, it fills the gap between the lamp and the T-shaped keel, and the overall installation effect is very good.

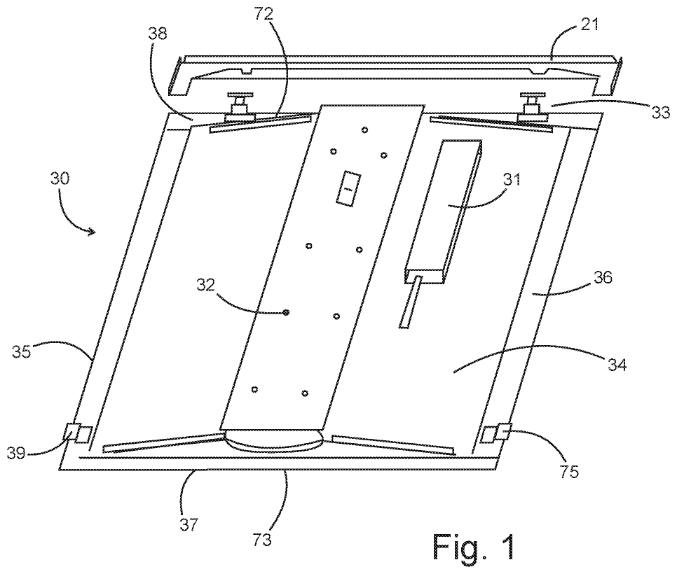

As seen in FIG. 1, the pivot rack 21 is a U-shaped piece that receives a front side 38 of the lamp 30. The lamp 30 has a ballast or driver 31 installed on the lamp 30 and also has an LED box 32 mounted to a middle portion of the lamp 30. The front side 38 engages the pivot rack 21, and the left side 37 initially is free and then swings to a horizontal engaged position. The lamp 30 has a rear side 37 and a front side 38. A pair of edge retainers 50 can be mounted on edge retainer mount areas 39. The reflector 34 is mounted with the LED box 32. A pair of spade hooks 33 engage to the pivot rack 21 so that the lamp 30 hangs from the spade hooks 33.

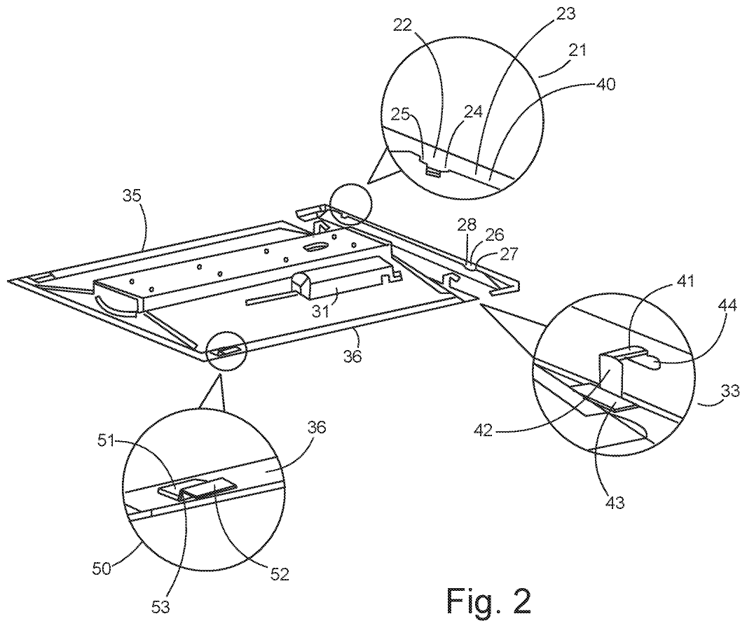

As seen in FIG. 2, the pivot rack 21 has a rack vertical portion 40. The rack vertical portion 40 is cut with a pair of notches including a first notch 22 and a second notch 26. The first notch 22 has a first notch right shoulder 24 and a first notch left shoulder 25. The second notch has a second notch right shoulder 27 and a second notch left shoulder 28. The notches and the notch shoulders are formed on a rack upper edge 23 of the pivot rack 21. The ballast or driver 31 is preferably a low-profile unit arranged on a top side of the lamp. When the hooks are engaged to the shoulders, the shoulders are sloped so that the hooks naturally slide into the first notch 22 and the second notch 26 like a funnel. The hooks engage to the first notch 22 and the second notch 26 and can have a snap fit to them. The spade hook 33 has a spade hook base 43 which could be spot welded to the front side 38 of the frame of the lamp 30. A spade hook post 42 extends vertically from the spade hook base 43. A spade hook top panel 41 extends horizontally from the spade hook post 42. A spade hook tip panel 44 extends laterally from the spade hook top panel 41.

The spade hook 33 has a pair of protruding ends that provides a secure connection. The rear side 35 and the front side 36 are fitted with one or more edge retainers 50. An edge retainer has an edge retainer base 51 from which extends the edge retainer extension tab 52. The edge retainer extension tab 52 extends to an edge retainer protruding portion 53 which is a foot that biases and supports the lamp 30.

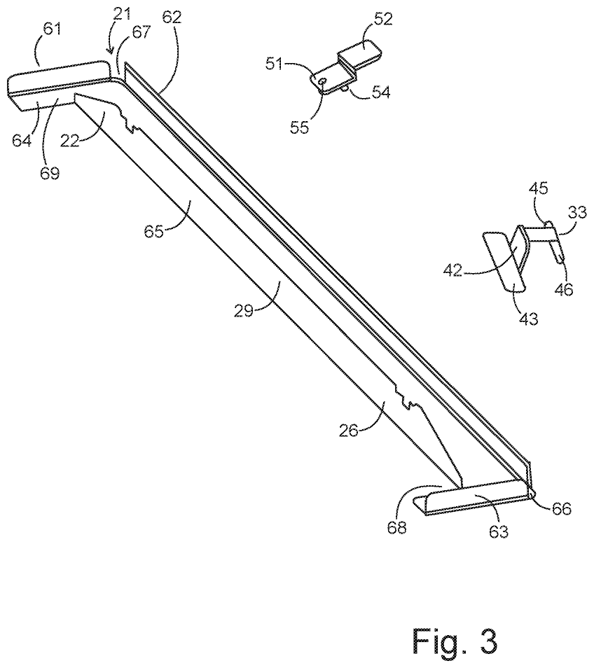

As seen in FIG. 3, a detailed diagram of the pivot rack 21 shows the inside rack vertical portion 29 cut with the pair of notches where the first notch 22 is parallel to the second notch 26. The inside rack vertical portion 29 is parallel to the second vertical edge panel 62 which is also vertical.

The spade hook 33 has a first tip end 45 and a second tip end 46. The tip ends are preferably rectangular or angular so that they will catch on the groups formed on the inside rack vertical portion 29. The edge retainer has an edge retainer hole 55 formed on the edge retainer base 51. The edge retainer extension tab 52 extends outwardly and pivots when the edge retainer extension handle 54 rotates the edge retainer from the disengaged position to the engaged position.

The first vertical edge panel 61 and the third vertical edge panel 60 are preferably parallel to each other and perpendicular to the inside rack vertical portion 29, and the second vertical edge panel 62. The horizontal portion 64 connects the third vertical edge panel 63 to the first vertical edge panel 61, and the third vertical edge panel 63. On the horizontal portion 64, a first inside opening 68 forms a gap between the first vertical edge panel 61 and the inside rack vertical portion 29. The on the horizontal portion 64, a second inside opening 69 forms a gap between the inside rack vertical portion 29 and the third vertical edge panel 63. The web section 65 is the vertical panel that is parallel to the second vertical edge panel. The pivot rack 21 has a first corner opening 66 and a second corner opening 67 formed between the second vertical edge panel 62, and the first vertical edge panel 61 and the third vertical edge panel 63.

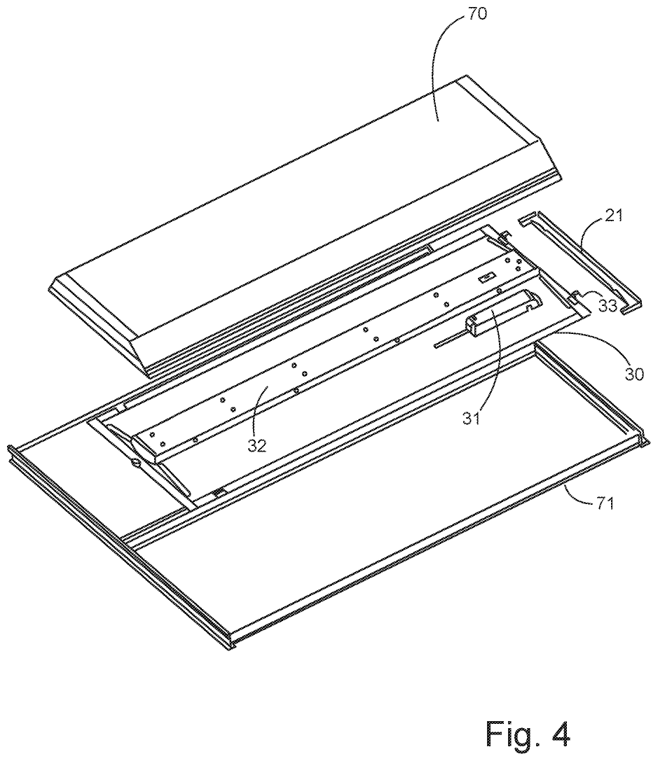

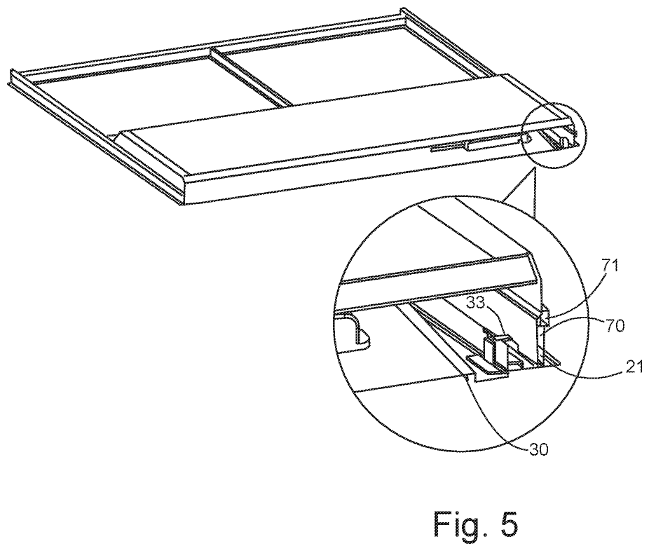

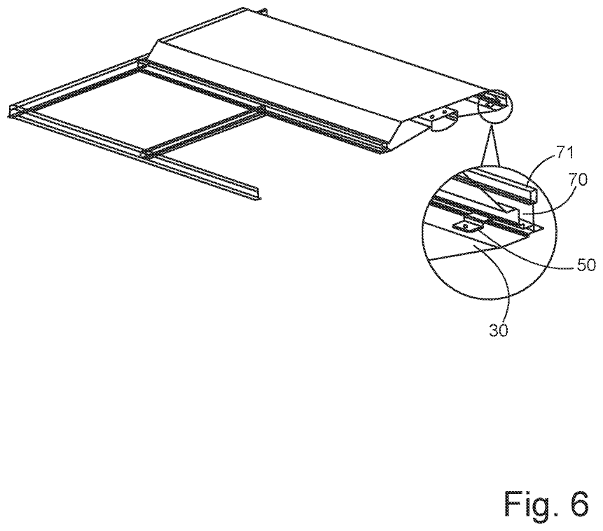

As seen in FIG. 4, the pivot rack 21 can install on a long retrofit lamp 30. Preferably, the lamp 30 has the ballast or driver 31 installed near the pivot end of the lamp 30 on the front side 38 so that the pivot end faces the pivot rack 21. The LED box 32 fits within the troffer housing 70 and the lamp 30 rests on the T-bar frame 71. As seen in FIG. 5, the pivot rack 21 engages with the T-bar frame 71 and troffer housing 70 to secure the lamp 30. As seen in FIG. 6, the T-bar frame 71 supports the troffer housing 70, and the edge retainer 50 retains the lamp 30

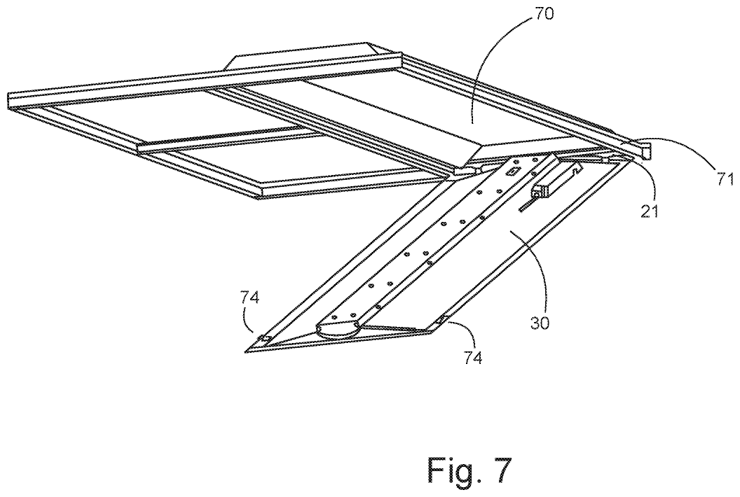

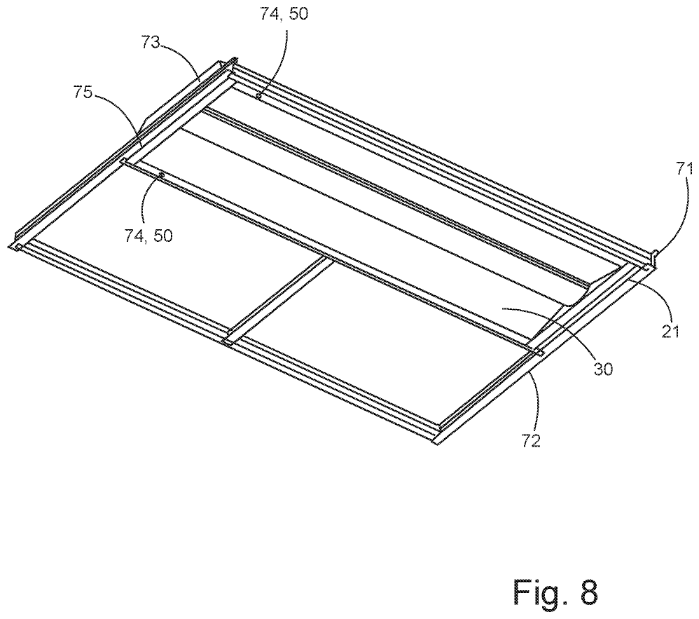

As seen in FIG. 7, installation of the pivot rack 21 to the T-bar frame 71 allows the lamp 30 to pivot from an open position to an engaged stowed position within the troffer housing 70. As seen in FIG. 8, the pivot rack 21 can be engaged to a T-bar frame 71 to hold up the pivot end of the lamp 30. At the opposite end of the pivot rack 21. The engagement latches can be slide latches or pivot latches at the

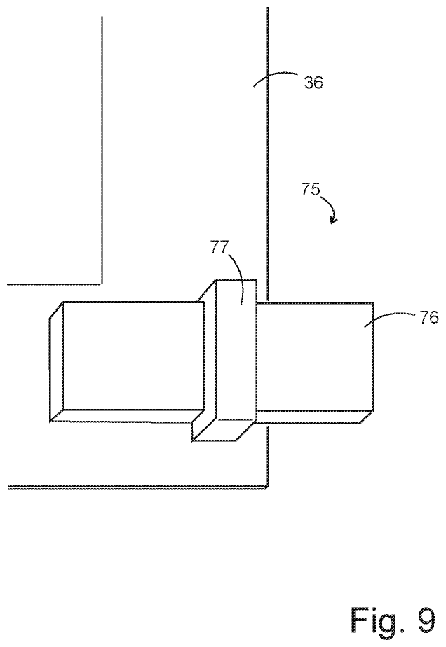

As seen in FIG. 8, the T-bar frame 71 engages to the lamp 30 at the pivot end 72, but also at the distal end 73. The distal end can retain to the T-bar frame 71 at a pair of pivot latches 74 or a pair of slide latches 75. As seen in FIG. 9, a slide latch can secure the lamp 30 to the T-bar frame 71 on the distal end 73.

1. A retrofit light mount comprising:
a. a pivot rack, wherein the pivot rack is elongated, wherein the pivot rack is configured to install to a T-bar frame;
b. a lamp having an LED box and a reflector, wherein the lamp has a pivot end and a distal end;
c. a pair of spade hooks formed on the pivot end, including a first spade hook and a second spade hook;
d. an inside rack vertical portion formed on the pivot rack, wherein the inside rack vertical portion is a vertically oriented panel; and
e. a first notch and a second notch formed on the inside rack vertical portion, wherein the first notch is configured to receive the first spade hook, and wherein the second notch is configured to receive the second spade hook.

2. The retrofit light mount of claim 1, further comprising a first notch right shoulder and a first notch left shoulder, wherein the first notch right shoulder is formed to the right of the first notch, wherein the first notch left shoulder is formed to the left of the first notch, wherein the first notch right shoulder slopes toward the first notch, and wherein the first notch left shoulder slopes toward the first notch.

3. The retrofit light mount of claim 1, further comprising a second notch right shoulder and a second notch left shoulder, wherein the second notch right shoulder is formed to the right of the second notch, wherein the second notch left shoulder is formed to the left of the second notch, wherein the second notch right shoulder slopes toward the second notch, and wherein the second notch left shoulder slopes toward the second notch.

4. The retrofit light mount of claim 1, wherein the pivot rack has a U shape when viewed from above.

5. The retrofit light mount of claim 1, wherein the spade hook has a spade hook base, wherein a spade hook post extends upwardly from the spade hook base, wherein the spade hook top panel extends forwardly from the spade hook post, wherein the spade hook tip panel extends downwardly from the spade hook top panel.

6. The retrofit light mount of claim 1, wherein the lamp further includes an edge retainer mounted at a distal end, wherein the edge retainer has an edge retainer base connected to the lamp, wherein an edge retainer protruding portion extends upwardly from the edge retainer base, wherein an edge retainer extension tab extends laterally from the edge retainer protruding portion.

7. The retrofit light mount of claim 1, wherein the pivot rack further includes a second vertical edge panel forward of the inside rack vertical portion, wherein the second vertical edge panel is parallel to the inside rack vertical portion.

8. The retrofit light mount of claim 7, wherein the pivot rack further includes a first vertical edge panel and a third vertical edge panel, wherein the first vertical edge panel is parallel to the third vertical edge panel, wherein the first vertical edge panel is perpendicular to the inside rack vertical portion, wherein the third vertical edge panel is perpendicular to the inside rack vertical portion, wherein the third vertical edge panel is spaced apart from the inside rack vertical portion at a first inside opening, wherein the first vertical edge panel is spaced apart from the inside rack vertical portion at a second inside opening.

9. The retrofit light mount of claim 8, further comprising a first notch right shoulder and a first notch left shoulder, wherein the first notch right shoulder is formed to the right of the first notch, wherein the first notch left shoulder is formed to the left of the first notch.

10. The retrofit light mount of claim 8, further comprising a second notch right shoulder and a second notch left shoulder, wherein the second notch right shoulder is formed to the right of the second notch, wherein the second notch left shoulder is formed to the left of the second notch.

11. The retrofit light mount of claim 8, wherein the pivot rack has a U shape when viewed from above.

12. The retrofit light mount of claim 8, wherein the spade hook has a spade hook base, wherein a spade hook post extends upwardly from the spade hook base, wherein the spade hook top panel extends forwardly from the spade hook post, wherein the spade hook tip panel extends downwardly from the spade hook top panel.

13. The retrofit light mount of claim 8, wherein the lamp further includes an edge retainer mounted at a distal end, wherein the edge retainer has an edge retainer base connected to the lamp, wherein an edge retainer protruding portion extends upwardly from the edge retainer base, wherein an edge retainer extension tab extends laterally from the edge retainer protruding portion.

14. A retrofit light mount comprising:
a. a pivot rack, wherein the pivot rack is elongated, wherein the pivot rack has a U shape when viewed from above, wherein the pivot rack is configured to install to a T-bar frame;
b. a lamp having an LED box and a reflector, wherein the lamp has a pivot end and a distal end;
c. a pair of spade hooks formed on the pivot end, including a first spade hook and a second spade hook;
d. an inside rack vertical portion formed on the pivot rack, wherein the inside rack vertical portion is a vertically oriented panel;
e. a first notch and a second notch formed on the inside rack vertical portion, wherein the first notch is configured to receive the first spade hook, and wherein the second notch is configured to receive the second spade hook;
f. a first notch right shoulder and a first notch left shoulder, wherein the first notch right shoulder is formed to the right of the first notch, wherein the first notch left shoulder is formed to the left of the first notch, wherein the first notch right shoulder slopes toward the first notch, and wherein the first notch left shoulder slopes toward the first notch; and
g. a second notch right shoulder and a second notch left shoulder, wherein the second notch right shoulder is formed to the right of the second notch, wherein the second notch left shoulder is formed to the left of the second notch, wherein the second notch right shoulder slopes toward the second notch, and wherein the second notch left shoulder slopes toward the second notch.

15. The retrofit light mount of claim 14, wherein the spade hook has a spade hook base, wherein a spade hook post extends upwardly from the spade hook base, wherein the spade hook top panel extends forwardly from the spade hook post, wherein the spade hook tip panel extends downwardly from the spade hook top panel.

16. The retrofit light mount of claim 14, wherein the lamp further includes an edge retainer mounted at a distal end, wherein the edge retainer has an edge retainer base connected to the lamp, wherein an edge retainer protruding portion extends upwardly from the edge retainer base, wherein an edge retainer extension tab extends laterally from the edge retainer protruding portion.

17. The retrofit light mount of claim 14, wherein the pivot rack further includes a second vertical edge panel forward of the inside rack vertical portion, wherein the second vertical edge panel is parallel to the inside rack vertical portion.

18. The retrofit light mount of claim 17, wherein the pivot rack further includes a first vertical edge panel and a third vertical edge panel, wherein the first vertical edge panel is parallel to the third vertical edge panel, wherein the first vertical edge panel is perpendicular to the inside rack vertical portion, wherein the third vertical edge panel is perpendicular to the inside rack vertical portion, wherein the third vertical edge panel is spaced apart from the inside rack vertical portion at a first inside opening, wherein the first vertical edge panel is spaced apart from the inside rack vertical portion at a second inside opening.
